(19) United States
(12) Patent Application Publication
(10) Pub. No.: US 2007/0295541 A1
(43) Pub. Date: Dec. 27, 2007

(54) SURFACE ACOUSTIC WAVE TOUCH PANEL FOR AUTOMATICALLY ADJUSTING STRENGTH OF RECEIVED SIGNAL

(75) Inventor: Shang Tai Yeh, Zhonghe City (TW)

Correspondence Address: SNELL & WILMER L.L.P. (Main), 400 EAST VAN BUREN, ONE ARIZONA CENTER, PHOENIX, AZ, 85004-2202, US

(73) Assignee: EGALAX_EMPIA TECHNOLOGY INC., Taipei City (TW)

(21) Appl. No.: 11/688,350

(22) Filed: Mar. 20, 2007

(30) Foreign Application Priority Data
Jun. 27, 2006 (TW) 95123170

(51) Int. Cl. G06F 3/043

(52) U.S. Cl. 178/18.04

(57) ABSTRACT

A surface acoustic wave (SAW) touch panel for automatically adjusting the strength of the received signal is provided. The issue of different decay levels between the SAW signals caused by panels of different vendors or materials is solved.

### CROSS-REFERENCE TO RELATED APPLICATIONS

This application claims the right of priority based on Taiwan Patent Application No. 95123170 entitled “Surface Acoustic Wave Touch Panel for Automatically Adjusting The Strength of the Received Signal,” filed on Jun. 27, 2006, which is incorporated herein by reference and assigned to the assignee hereof.

### TECHNICAL FIELD

The present invention relates to a touch panel, and more particularly to a surface acoustic wave touch panel.

### BACKGROUND OF THE INVENTION

General input interfaces of electronic devices are keyboards or mice, rather than intuitional tools operated by voice or hand. Keyboards or mice are not friendly to people unfamiliar with the operation of electronic devices. Therefore, the best-developed one among input interfaces other than keyboards or mice is the touch panel.

The touch panel was originally developed for military applications by the American military in the 1970s, employed by non-governmental uses in the 1980s and then broadly applied. The touch panel is now the simplest one of the human-machine interfaces to use. As a finger or a pen touches or writes on the panel, the locations of touch or writing would be obtained through an internal means and transmitted to the electronic device; thus the input is done. The employment of the touch panel may lower the barrier between human and machine, and the users may interact with the electronic devices in a most intuitional way is almost without learning. Therefore, the touch panels are employed broadly, such as in eBook, GPS, PDA, web phone, mini notebook, web pad, hand-held PC, etc.

The touch panels may be resistive type, capacitive type, infrared type and surface acoustic wave type. The working principle of the surface acoustic wave type touch panel is as follows. An acoustic wave is propagated over the surface of an object, and if another object touches the surface, the propagation of the acoustic wave is blocked. And the location at which the object touches may be judged according to the block. As known by people skilled in the art, typically, a wedge or a comb is utilized to generate surface acoustic wave. They both generate a bulk wave through a piezoelectric plate transducer, and transform tile bulk wave into a Rayleigh wave. The Rayleigh wave was first derived from an earthquake related research by the English physicist Lord Rayleigh in 1885 and later proved in earthquake records; thus a surface acoustic wave is also referred to as a Rayleigh wave.

Referring to FIGS. 1A and 1B, a top view and a perspective view of a surface acoustic wave touch panel 100 according to the prior art are shown. The surface acoustic wave touch panel 100 includes a panel, an X-axis transmitting transducer 114, an X-axis receiving transducer 116, a Y-axis transmitting transducer 124 and a Y-axis receiving transducer 126. The panel has a surface 104, a first side face 106, a second side face 108, a third side face 110 and a fourth side face 112. The transducers mentioned above are devices transducing between mechanical energy and electric energy through the piezoelectric effect. Furthermore, the surface 104 includes reflective stripes of variable density 190, 191, 192 and 193. The surface wave generated by the X-axis transmitting transducer 114 is reflected by the reflective stripes 193 and propagated in the +X direction, then reflected by the reflective stripes 191 and propagated in the +Y direction, and finally received by the X-axis receiving transducer 116 and transduced into electric energy. Similarly, the surface wave generated by the Y-axis transmitting transducer 124 is reflected by the reflective stripes 192 and propagated in the +Y direction, then reflected by the reflective stripes 190 and propagated in the +X direction, and finally received by the Y-axis receiving transducer 126 and transduced into electric energy. Take X-axis as an example, referring to FIGS. 2 and 3, FIG. 2 illustrates a waveform of voltage generated by the X-axis receiving transducer as the panel not touched by an object, and FIG. 3 illustrates a waveform of voltage generated by the X-axis receiving transducer as the panel touched by an object. The touch of the object may have some energy of the surface acoustic wave absorbed by the object, and cause a dip of the waveform. Surface waves reflected by different reflective stripes 191 and 193 may have different travel distances, thus the X-coordinate of the touch point may be judged. The Y-coordinate of the touch point may be judged similarly.

However, panels of different materials would have different decay levels of the surface acoustic wave; thus the amplitudes of the signals vary. And the decay levels would be different even when the materials are the same, if the vendors vary. Accordingly, a surface acoustic wave touch panel for automatically adjusting the strength of the received signal is needed.

### SUMMARY OF THE INVENTION

One object of this invention is to provide a surface acoustic wave touch panel for automatically adjusting the strength of the received signal. The surface acoustic wave touch panel includes at least one first unit for generating at least one surface acoustic wave; a second unit for generating a plurality of bursts to drive the first unit; a panel for propagating the surface acoustic wave; at least one third unit for receiving a propagated surface acoustic wave from the panel and Outputting a voltage signal; a fourth unit connected to the third unit for processing the voltage signal and outputting a processed signal; a fifth unit connected to the fourth unit for digitalizing the processed signal and outputting a digital signal; and a sixth unit connected to the second unit and the fifth unit, to control the strength of the propagated surface acoustic wave received by the third unit, the sixth unit is configured to adjust a number of the plurality of bursts generated by the second unit according to the digital signal.

### BRIEF DESCRIPTION OF THE DRAWINGS

FIG. 1A shows a top view of a surface acoustic wave touch panel according to the prior art;

FIG. 1B shows a perspective view of a surface acoustic wave touch panel according to the prior art;

FIG. 2 illustrates a waveform of voltage generated by the receiving transducer as the panel is not touched by an object;

FIG. 3 illustrates a waveform of voltage generated by the receiving transducer as the panel is touched by an object;

FIG. 4 depicts a surface acoustic wave touch panel for automatically adjusting the strength of the received signal;

FIG. 5 illustrates a waveform of voltage received by the third unit 408; and

FIG. 6 illustrates a waveform of voltage received by the third unit 408 after the adjustment of the sixth unit 414.

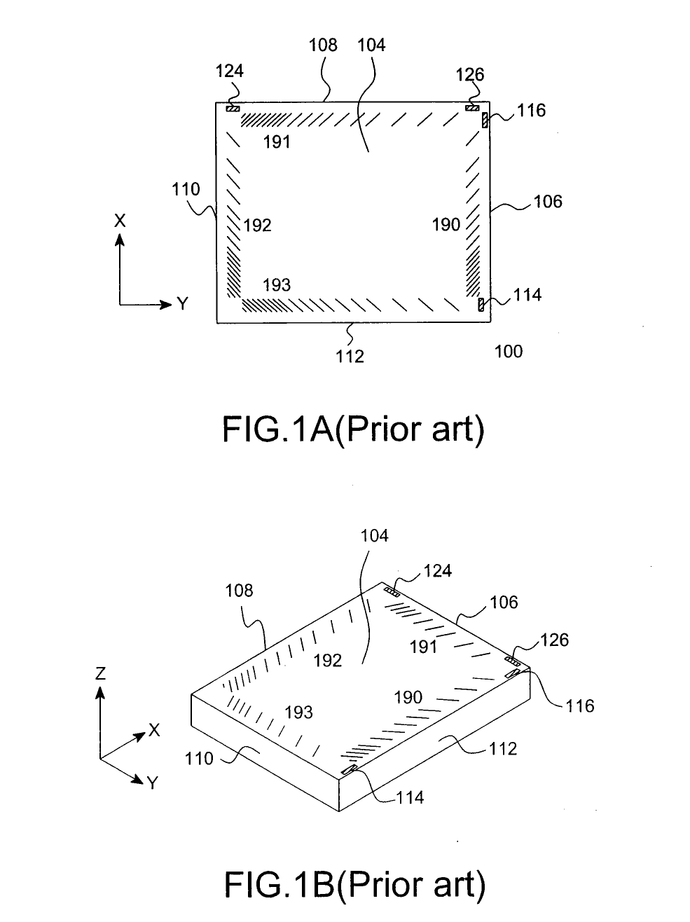

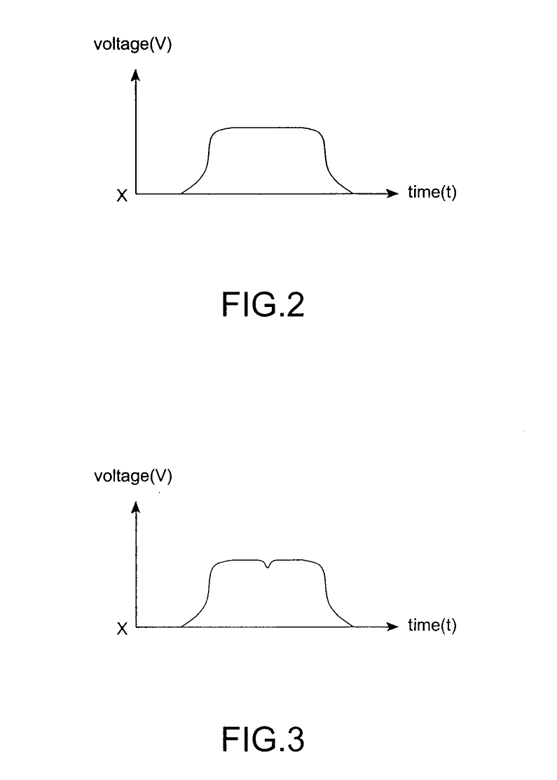

### DETAILED DESCRIPTION OF THE PREFERRED EMBODIMENTS

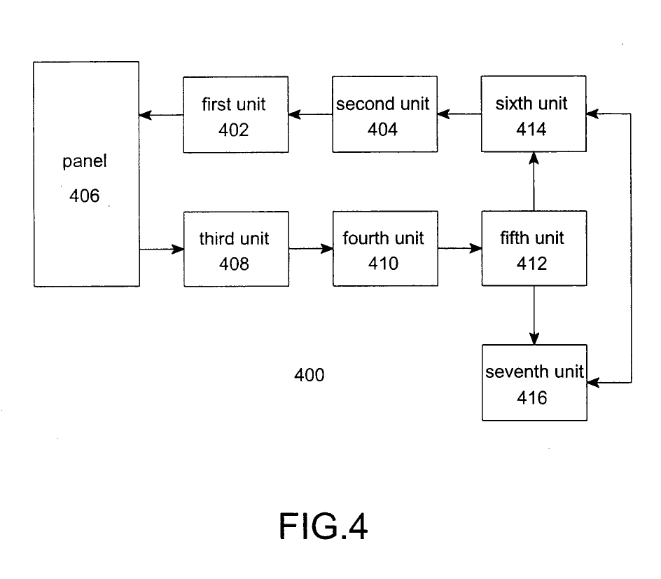

A surface acoustic wave touch panel for automatically adjusting the strength of the received signal is disclosed by the present invention. To make the description of the present invention more detailed and complete, the following description is presented in conjunction with FIGS. 4-6.

Referring to FIG. 4, in one embodiment, the present invention provides a surface acoustic wave touch panel 400 for automatically adjusting the strength of the received signal. The surface acoustic wave touch panel 400 includes the following. At least one first unit 402, such as the above mentioned wed,e transducer, comb transducer or other transducers capable of transducing electric energy into mechanical energy, is for generating at least one surface acoustic wave. A second unit 404 is for generating a plurality of bursts to drive the first unit 402. A panel 406, such as panels made of glass, plastic or acrylic, is for propagating the surface acoustic wave. At least one third unit 408, such as the above mentioned wedge transducer, comb transducer or other transducers capable of transducing mechanical energy into electric energy, is for receiving a propagated surface acoustic wave from the panel and outputting a voltage signal. A fourth unit 410, such as a filter, is connected to the third unit 408 for processing the voltage signal and outputting a processed signal. A fifth unit 412, such as an analog-to-digital converter, is connected to the fourth unit 410 for digitalizing the processed signal and outputting a digital signal. And a sixth unit 414, such as a microprocessor or a central processing unit, is connected to the second unit 404 and the fifth unit 412. To control the strength of the propagated surface acoustic wave received by the third unit 408, the sixth unit 414 is for adjusting a number of the plurality of bursts generated by the second unit 404 according to the digital signal. Additionally, the surface acoustic wave touch panel 400 may further include a seventh unit 416, such as a static random access memory, a dynamic random access memory, a flash memory or other memory devices. The seventh unit 416 is connected to the fifth unit 412 and the sixth unit 414 for storing the digital signal outputted by the fifth unit 419, and may also be utilized by the sixth unit 414 anytime.

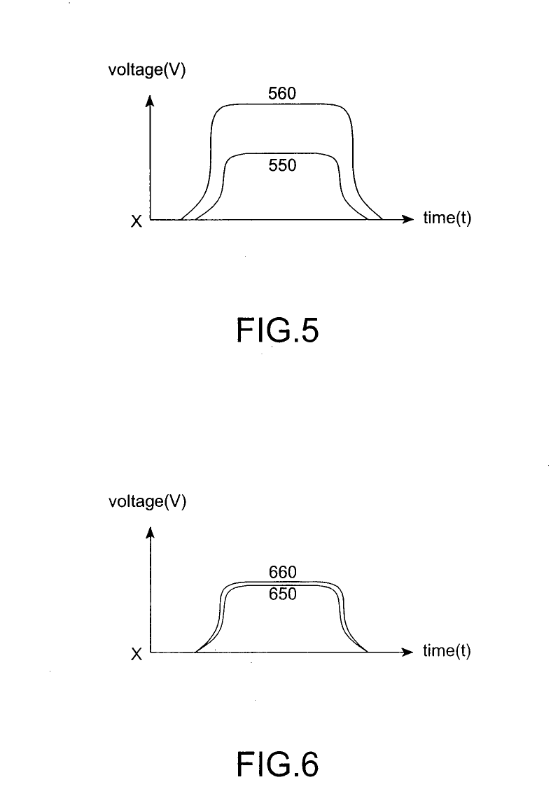

Further description refers to FIGS. 5 and 6 along with FIG. 4. The numerals 550 and 560 in FIG. 5 respectively represent the initial states of the waveforms of the voltages generated by the third unit 408 (shown in FIG. 4) working with panels provided by the vendor A and the vendor B. The panels from the vendors A and B are of different materials, thus a strength difference exists between the waveforms of the voltages generated by the third unit 408 (shown in FIG. 4). However, after some time, by the adjustment of the sixth unit 414 through controlling the number of bursts generated by the second unit 404 (shown in FIG. 4), the waveforms of the voltages generated by the third unit 408 (shown in FIG. 4) may gradually tend to have a predetermined strength, as 650 and 660 shown in FIG. 6. Consequently, the different decay levels between the surface acoustic waves and thus different strengths between signals caused by panels of different vendors or materials are alleviated. Therefore, the optimization of the signal of the surface acoustic wave is achieved.

The above description is only for preferred embodiments, but not to limit the scope of the present invention. Any other equivalent changes or modifications performed with the spirit disclosed by the present invention should be included in the appended claims.

We claim:

1. A surface acoustic wave touch panel for automatically adjusting the strength of the received signal, comprising:
at least one first unit for generating at least one surface acoustic wave;
a second unit for generating a plurality of bursts to drive said first unit;
a panel for propagating said surface acoustic wave;
at least one third unit for receiving a propagated surface acoustic wave from said panel and outputting a voltage signal;
a fourth unit connection to said third unit for processing said voltage signal and outputting a processed signal;
a fifth unit connected to said fourth unit for digitalizing said processed signal and outputting a digital signal; and
a sixth unit connected to said second unit and said fifth unit, to control the strength of said propagated surface acoustic wave received by said third unit, said sixth unit being for adjusting a number of said plurality of bursts generated by said second unit according to said digital signal.

2. The surface acoustic wave touch panel according to claim 1, further comprising:
a seventh unit connected to said fifth unit and said sixth unit for storing said digital signal.

3. The surface acoustic wave touch panel according to claim 1, wherein said first unit comprises a piezoelectric unit.

4. The surface acoustic wave touch panel according to claim 1, wherein said panel has reflective stripes of variable density.

5. The surface acoustic wave touch panel according to claim 1, wherein said panel is made of glass, plastic or acrylic.

6. A surface acoustic wave touch panel for automatically adjusting the strength of a signal, comprising:
at least one acoustic wave generating unit for generating at least one surface acoustic wave;
a panel for propagating said surface acoustic wave;
at least one acoustic wave receiving unit for receiving a propagated surface acoustic wave from said panel; and
an adjusting unit for adjusting the strength of said surface acoustic wave generated by said acoustic wave generating unit according to said propagated surface acoustic wave.

7. The surface acoustic wave touch panel according to claim 6, wherein said acoustic wave generating unit comprises:
a piezoelectric unit; and
a burst generating unit for driving said piezoelectric unit.

8. The surface acoustic wave touch panel according to claim 6, wherein said adjusting unit adjusts a number of bursts generated by said burst generating unit.

9. The surface acoustic wave touch panel according to claim 6, wherein said panel has reflective stripes of variable density.

10. The surface acoustic wave touch panel according to claim 6, wherein said panel is made of glass, plastic or acrylic.
